(19) United States
(12) Patent Application Publication
(10) Pub. No.: US 2012/0134652 A1
(43) Pub. Date: May 31, 2012

(54) PROXY DIGITAL VIDEO RECORDER

(75) Inventors: Kulvir S. Bhogul, Pflugerville, TX (US); Gregory J. Boss, Saginaw, MI (US); Rick A. Hamilton, II, Charlottesville, VA (US); Brian M. O'Connell, Cary, NC (US)

(73) Assignee: INTERNATIONAL BUSINESS MACHINES CORPORATION, Armonk, NY (US)

(21) Appl. No.: 12/955,723

(22) Filed: Nov. 29, 2010

(51) Int. Cl. H04N 5/92; H04N 5/76

(52) U.S. Cl. 386/299; 386/326; 386/E05.009; 386/E05.001

(57) ABSTRACT

A proxy-based digital video recording system and method, including receiving a request to record a video program from a requesting user and transmitting a request for the video program over a network to a first provider server. The requested video program is received and stored in memory according to a first provider format. A digital video format of a digital video recorder associated with the requesting user is determined, the stored video program is converted from the first provider format to the digital video format, and the converted video program is transmitted to the digital video recorder.

### BACKGROUND

1. Field

This disclosure relates generally to digital video recorders, and, more particularly, to proxy-based digital video recording.

2. Background

Digital video recorders (“DVR”) and personal video recorders (“PVR”) are devices that record video to a disk drive or other storage medium for playback at a later time. These devices include standalone set-top recording devices and software programs for personal computers. Generally, these devices enable many enhancements to broadcast video entertainment experience, such as time-shifting, pausing live television broadcasts, instant replay, “chasing” playback and the ability to skip advertisements.

### BRIEF SUMMARY

In one aspect of this disclosure, a proxy-based digital video recording system and method are disclosed. The proxy-based digital video recording system and method comprise receiving a request to record a video program from a requesting user and transmitting a request for the video program to a first provider server. The requested video program is received and stored in memory according to a first provider format. A digital video format of a digital video recorder associated with the requesting user is determined, the stored video program is converted from the first provider format to the digital video format, and the converted video program is transmitted to the digital video recorder.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE SEVERAL VIEWS OF THE DRAWINGS

This disclosure is further described in the detailed description that follows, with reference to the drawings, in which:

FIG. 1 is a high-level representation of an illustrative proxy-based digital video recording system;

FIG. 2 is a flow chart representing a preferred sequence of steps for implementing the proxy-based digital video recording system of FIG. 1;

FIG. 3 is a flow chart representing an alternative preferred sequence of steps for implementing the proxy-based digital video recording system of FIG. 1;

FIG. 4 is a flow chart representing a continuing preferred sequence of steps from FIG. 1 or 2 for implementing the proxy-based digital video recording system of FIG. 1; and

FIG. 5 is a flow chart representing a continuing preferred sequence of steps from FIG. 4 for implementing the illustrative proxy-based digital video recording system of FIG. 1.

### DETAILED DESCRIPTION

This application discloses a proxy-based digital video recording system 100, which decouples digital video recorders from subscription-based providers. Subscription-based program providers often use proprietary digital video formats with proprietary digital video recorder units. These proprietary digital video recorder units typically accept only a limited range of digital video formats, preventing users from using them to record programs broadcasted by competing networks. This places artificial limitations on both the broadcast programming available to digital video recorder users, and the user-base from which subscription-based program providers may draw revenue. The interposition of a proxy digital video recorder, with the ability to translate digital video programming from one format to another, removes these limitations. A larger selection of programming may be available for download by users and subscription-based providers may expand the user base from which they may draw revenue.

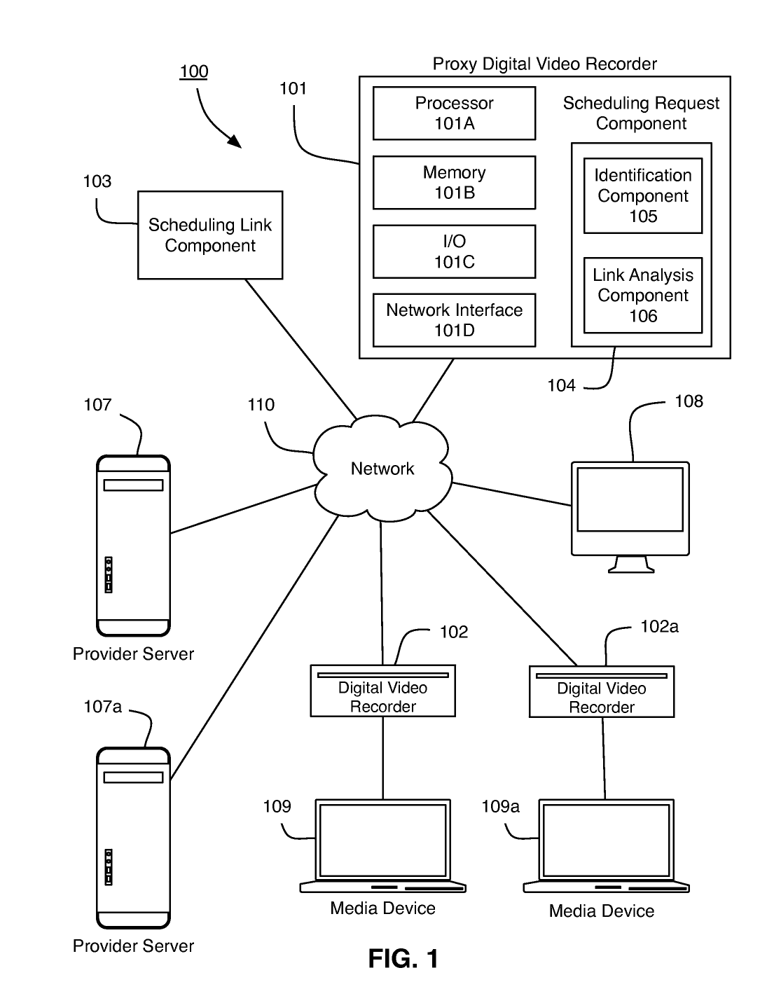

FIG. 1 is a high-level representation of an illustrative proxy-based digital video recording system 100 and related operating components. Network 110 may represent any aggregate network of computer or computer-implemented devices, such as (but not limited to) a local area network, wide area network, intranet, extranet, or preferably, the global Internet. Network 110 may operate concurrently on multiple mediums, including copper (such as Ethernet and coaxial enabled networks), fiber-optic (including fiber-to-the-node, fiber-to-the-curb, fiber-to-the-cabinet, fiber-to-the-last-amplifier, etc.), telephone network and wireless networks. Network 110 may allow intercommunication between non-local devices, such as (but not limited to) one or more user computers 108, proxy digital video recorder 101, one or more digital video recorders 102, 102a, and one or more video provider servers 107, 107a.

User computer 108 may represent a personal computer or personal computing device with Internet browsing functionality and a network connection. Such devices may include (but are not limited to) laptop computers, desktop computers, smart phones, touch-screen tablets and other such devices. Users may utilize user computer 108 to access programming schedules and program advertisements having hyperlinks, the selection of which may instruct proxy digital video recorder 101 to schedule digital video recording sessions.

Digital video recorders 102, 102a may represent one or more network-enabled media recorder devices associated with a user, including (but not limited to) digital video recorders and personal video recorders, operating within any desirable format, including set-top boxes, portable media players, and televisions with built-in recording functionality. Digital video recorder 102, 102a preferably includes a processor for executing instructions and supporting hardware components (i.e., random access memory), storage medium for storing data (including process instructions or digital media) and a network connection for sending and receiving communication data over network 110. Digital video recorder 102 may be implemented using any combination of hardware and/or software components, or alternatively, all hardware or all software components.

Scheduling link component 103 is preferably an embedded HTML hyperlink. Scheduling link component 103 may be embedded in any suitable location, such as (but not limited to) a web page. For example, it may be embedded in a web-based advertisement (preferably) for the program that is being promoted. Therefore, a user on, for example, user computer 108 that sees the advertisement for the program and wishes to record the program may click on or otherwise select the advertisement (or link within the advertisement) to schedule a recording for the promoted program. Alternatively, the scheduling link component 103 may be embedded on an Internet enabled program guide for a network. For instance, link component 103 may be embedded on a schedule of programs and time slots. A user using, for example, user computer 108 may select the schedule entry for the program, triggering the link and automatically scheduling recording of the program. Other embodiments are also contemplated. For example, the link component 103 may be embedded on a program guide displayed on a media device 109, 109a, such as (but not limited to) a cable television program guide or a hotel television network program guide.

Scheduling link component 103 may take the form of a “directed” recording link that preferably includes detailed instructions for scheduling a recording, such as (but not limited to) broadcast start time, broadcast duration and station identification. Alternatively, a “descriptive” recording link may include a description of the recording, including information such as (but not limited to) media title, episode title/number (if applicable) or some unique identification code, if one has been implemented. In this embodiment, the proxy digital video recorder 101 would be responsible for searching through a media listing (such as a cable television electronic programming guide) to find the relevant program, and schedule a recording for it.

Proxy digital video recorder 101 preferably represents a computer-implemented system for scheduling, storing and converting digital video programming. Proxy digital video recorder 101 preferably operates as a distributed system on a “cloud” of computers, and may be implemented using Infrastructure as a Service (“IAAS”), Platform as a Service (“PAAS”) and/or Software as a Service (“SAAS”) cloud services. Alternatively, proxy digital video recorder 101 may be implemented on more conventional systems, using any combination of hardware and/or software components, or alternatively, all hardware or all software components. For example, proxy digital video recorder 101 may constitute pure software operating locally on one or more computer systems, such as user computer 108 or media device 109, 109a. Alternatively, proxy digital video recorder 101 may be implemented as a centralized web service, operating on one or more core servers located remotely on network 110.

The proxy digital video recorder 101 may include a processor 101A for executing program instructions and processes, memory 101B for storing data and instructions, and a network interface device 101D for providing access to network 110. Additional components may be added as desired. For example, proxy digital video recorder 101 may include interface input/output (I/O) devices 101C for direct human interaction, such as (but not limited to) keyboard and mouse (and other input devices) along with one or more displays.

Proxy digital video recorder 101 preferably includes a scheduling request component 104. The scheduling request component 104 may be responsible for handling incoming requests to schedule a program for recording. Scheduling request component 104 preferably includes two subcomponents to perform this task. The first is preferably an identification component 105, which ascertains the identity of a requesting user scheduling a video recording. Conventional methods may be used to implement the identification component 105, such as prompting for a user name and password, or analyzing the requesting user's Internet protocol address and correlating it with a known pre-registered user. A “cookie” may be presented to the requesting user's web browser to enable a requesting user to schedule multiple recordings without necessitating re-identification for each operation. Information identifying the requesting user's digital video recorder unit 102, 102a may also be interpreted by the identification component 105. For example, the user may transmit to or otherwise provide the identification component 105 with the name of the user's digital video recorder service subscription (such as TiVo® and the serial number of the TiVo® digital video recorder). This information would enable the proxy digital video recorder 101 to determine what formats are understood by the digital video recorder unit 102 associated with the requesting user.

The second component of the scheduling request component 104 is preferably a link analysis component 106. Once a scheduling request has been received, the link analysis component 106 preferably validates the request. Validation may include ensuring the recording request is correct and uncorrupted. After the request has been validated, the request is preferably stored in memory within or otherwise associated with the proxy digital video recorder 101, thereby scheduling a recording for the requesting user. The link analysis component 106 preferably supports both directed and descriptive link formats described above.

First and second video program providers 107 and 107a may represent servers owned and operated by video program providers, such as (but not limited to) cable or satellite television network providers. These may include servers operated by any provider entity from large aggregate providers of cable and satellite television (such as Time-Warner Cable®, Comcast®, Dish Network®, etc.) down to individual premium cable television networks (such as HBO®, Fox® and Starz®). The servers 107, 107a may be responsible for a multitude of tasks, such as hosting video programming, maintaining subscriber identification information, and managing licensing or subscription transactions. If the servers 107, 107a are used to store downloadable copies of digital programming, the digital video programming may be downloaded from these servers to proxy digital video recorder 101 over network 110.

Media devices 109, 109a may represent television units, computers, hand-held players and other devices on which users may display video recorded digital video programming. Media device 109, 109a and user computer 108 may, in some embodiments, be the same device. Examples of this embodiment may include situations where users schedule downloads on a computer, and the recorded programs are later displayed on the same computer. Alternatively, they may be separate devices. Examples may include embodiments where users schedule recordings on their computer, which are ultimately downloaded to a digital video recorder, which in turn displays the recorded program on a television. Media device 109 is preferably operatively connected to the digital video recorder unit 102 to enable display of programs stored on digital video recorder unit 102 on media device 109. Similarly, media device 109a is preferably operatively connected to the digital video recorder unit 102a to enable display of programs stored on digital video recorder unit 102a on media device 109a. Alternatively, digital video recorder unit 102 and media device 109, and digital video recorder 102a and media device 109a may be connected only through network 110 (such as when media device 109 and user computer 108 are a single entity), in which case programs stored on digital video recorder 102 may be streamed over network 110 to media device 109.

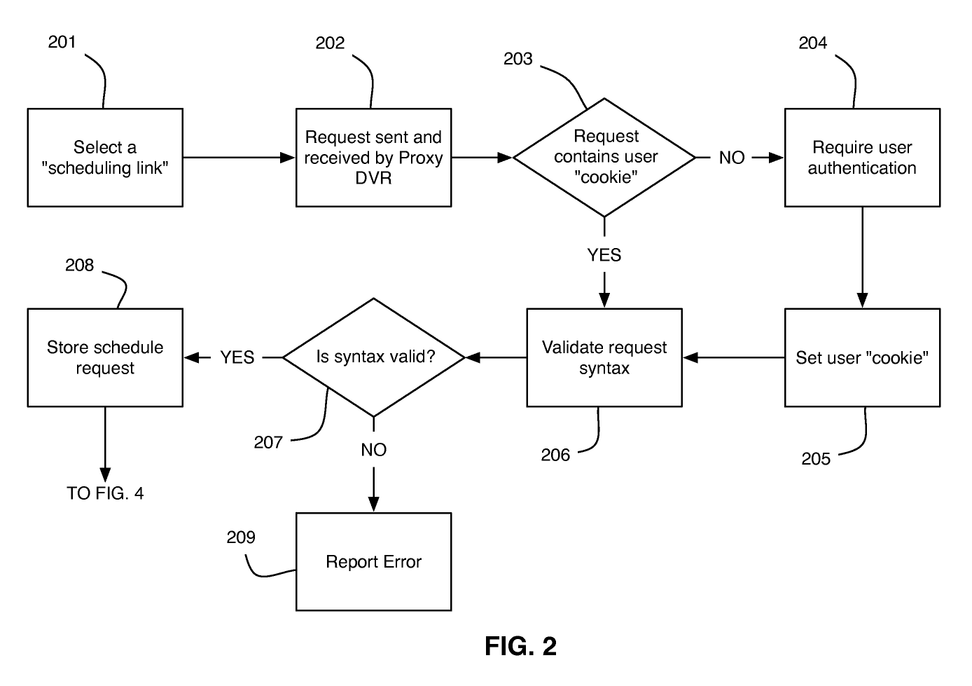

FIG. 2 is flow chart illustrating a preferred sequence of steps for implementing the proxy digital video recorder system 100. In step 201, a requesting user on, for example, user computer 108 may select a scheduling link component 103. As described above, scheduling link component 103 may be embedded as, for example, an advertisement promoting an associated video program, or an entry in a menu-driven television programming schedule. Users may, therefore, encounter the scheduling link component 103 by, for example, seeing an Internet advertisement for the program, or by browsing a network programming schedule on user computer 108. Users may then schedule a recording of the program by, for example, “mouse-click” selecting the advertisement or entry. Other implementations are also contemplated. For example, link component 103 may be embedded in an on-screen video program guide displayed on a television, such as a cable television menu-based directory or a hotel television program access system. A requesting user may indicate that the user wishes to schedule the program by navigating a highlighting cursor onto the appropriate entry and depressing a “select” button on the television remote control.

In step 202, selection of the link component 103 preferably causes user computer 108 to transmit a scheduling request over network 110 to the proxy digital video recorder 101 operating in the cloud. Subsequently, the proxy digital video recorder 101 (through identification component 105) may determine in step 203 whether the schedule request information includes a user hypertext “cookie,” which preferably contains at least identifying information for the requesting user. If no “cookie” exists, then in step 204, the proxy digital video recorder 101 may transmit an authentication request over network 110 to the user computer 108 (or other network enabled media device). This may cause a prompt or notice to be displayed to the user on the display of user computer 108, requiring (for example) input of a user name and password for the purposes of user authentication. Once the user submits the required information, a hypertext “cookie” may be set in step 205 (thereby storing user identification information for this session).

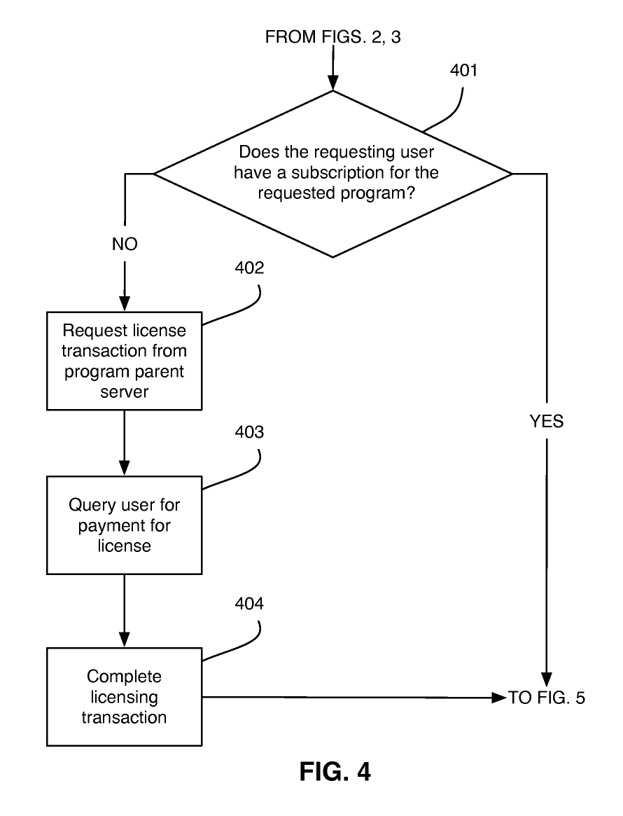

Once completed (or if the query from step 203 returned a positive result), then, in step 206, the proxy digital video recorder 101, through the link analysis component 106, may initiate a determination (utilizing cloud resources) as to whether the syntax of the request is valid. In step 207, the link analysis component 106 may utilize any conventional method to determine whether the syntax is valid. For example, the proxy digital video recorder 101 may parse the information in the request packet to determine if any data corruption has occurred. Checksum, cyclical redundancy check, parity bits, and other known methods of error detection may also be utilized as required. If the syntax is incorrect, then in step 209, the proxy digital video recorder 101 preferably reports an error over network 110 to the requesting user's computer 108 for display to the requesting user. If the syntax is correct, then, in step 208, proxy digital video recorder 101 preferably stores the schedule request in cloud resources (in association with the requesting user), and progresses to FIG. 4 (discussed further below).

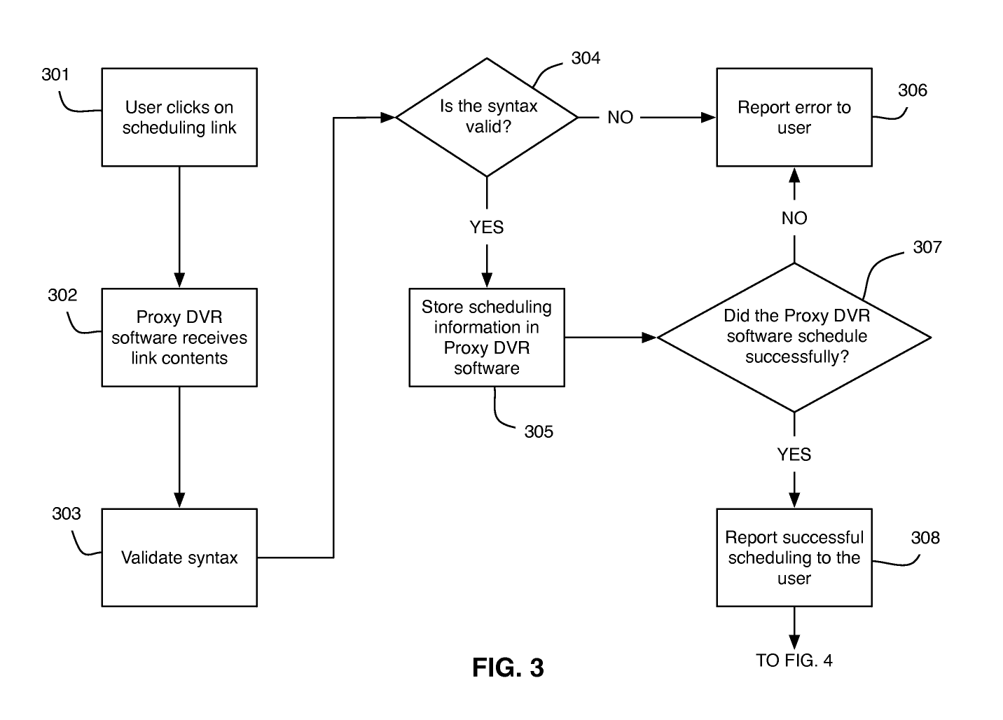

FIG. 3 is flow chart illustrating an alternative sequence of steps for implementing a software-based proxy digital video recorder installed on a user computer 108, rather than a cloud-based system. In step 301, a user may select a scheduling link component 103 in the same manner as described above. As with the embodiment of FIG. 2, the scheduling link component 103 is preferably embedded in an advertisement or program guide, which may be displayed on, for example, a webpage or television-driven menu. A requesting user on user computer 108 may select the link for scheduling by, for example, mouse-clicking on the hyperlink. In contrast to the embodiment of FIG. 2, however, the selection of the scheduling link component 103 preferably forwards the hyperlink contents to a local proxy digital video recorder software instance on computer 108 (rather than remotely over network 110 to a proxy digital video recorder 101).

In step 302, the local proxy digital video recorder 101 software instance preferably receives the scheduling link contents and, in step 303, the local proxy digital video recorder 101 may initiate syntax validation (utilizing link analysis component 106). As described above, in step 304, the local proxy digital video recorder 101 software instance may utilize any known method to determine whether the syntax is valid. For example, the local proxy digital video recorder 101 software instance may parse the information in the request to determine if any data corruption has occurred. Checksum, cyclical redundancy check, parity bits, and other known methods of error detection may also be utilized as required.

If the syntax of the request is determined to be invalid, then, in step 306, the local proxy digital video recorder 101 software instance preferably reports the syntax error to the user on user computer 108. If the syntax is determined to be valid, then, in step 305, the local proxy digital video recorder 101 software instance preferably stores the request on user computer 108.

In step 307, the local proxy digital video recorder 101 software instance may determine whether the scheduling information was stored successfully on user computer 108. If it did not, then, in step 306, the local proxy digital video recorder 101 software instance preferably reports the error to the user on user computer 108. Otherwise, in step 308, the local proxy digital video recorder 101 software instance preferably reports the successful scheduling request to the user on user computer 108, and the process preferably continues to FIG. 4.

FIG. 4 is flow chart illustrating a continuing preferred sequence of steps from FIG. 2 or 3 in which a license may be automatically obtained to download a video from a video provider. As described above, servers 107 and 107a may represent computer servers maintained by network providers for a multitude of tasks, such as (but not limited to) hosting video programming, maintaining subscriber identification information, and/or managing licensing or subscription transactions. Therefore, server 107 may represent, for example, a server maintained by a first provider (e.g., Time Warner Cable®), while server 107a may represent, for example, a server maintained by a second provider (e.g., Dish Network®).

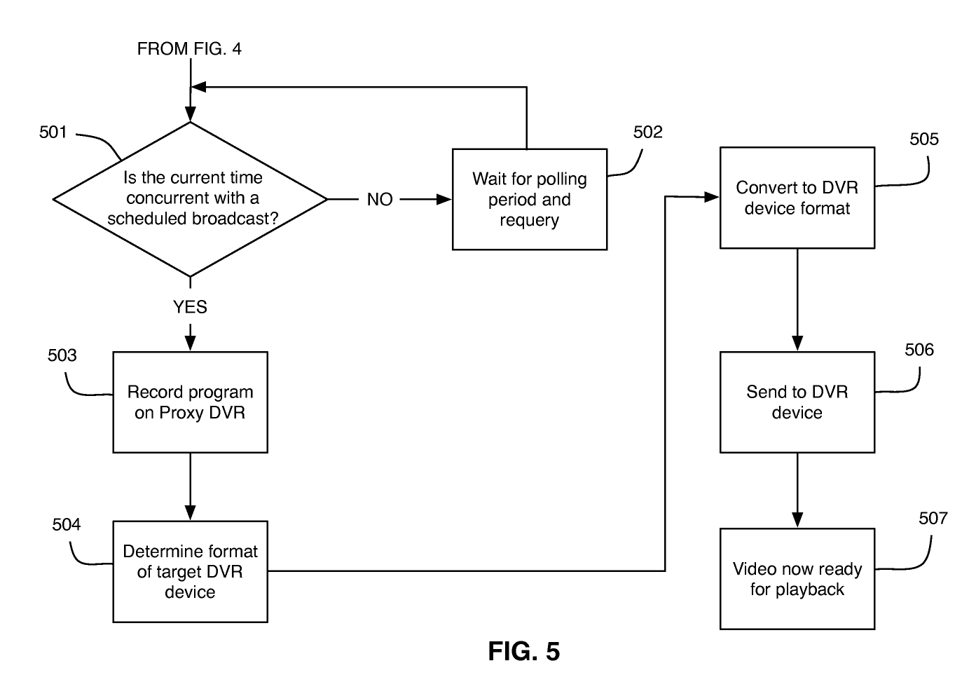

Once a program has been scheduled for recording (as performed in FIG. 2 or 3), then, in step 401, proxy digital video recorder 101 (or local proxy digital video recorder software instance) may query whether the requesting user has a subscription that allows the user access to the requested program. The requested program information (from the link component 103) may indicate to the proxy digital video recorder 101 on which network (and network server 107 or 107a) the program is located (e.g., the Dish Network®). For example, if the link component 103 indicates that a requested program is part of the Dish Network®, proxy digital video recorder 101 may then determine whether the requesting user has a valid subscription to Dish Network®. This may be accomplished in a variety of ways. For example, user authentication information (from, for example, step 204 of FIG. 2) may require an initial user registration, during which time the user may register program provider network(s) to which the user is subscribed (e.g., Time Warner Cable®). The proxy digital video recorder 101 may compare the registered program provider network(s) to the network associated with the requested program to determine whether the user has a subscription valid for the requested program. Alternatively, the user authentication information may contain basic information, such as the user's name, address, etc. This information may be compared to subscriber lists on the program provider server 107, 107a of the requested program (e.g., Dish Network's® server) to determine whether the user has an active subscription with the program provider associated with the requested program. If the proxy digital video recorder 101 determines that the user does have a subscription with the program provider associated with the requested program in step 401, the method preferably proceeds to FIG. 5A (described further below).

If, however, within the current example, the proxy digital video recorder 101 determines that the user (e.g., a Time Warner Cable® subscriber) lacks a subscription for program provider associated with the requested program (e.g., Dish Network®), then, in step 402, proxy digital video recorder 101 preferably requests a license transaction over network 110 from program provider server 107a (e.g., Dish Network®) associated with the requested program. In step 403, server 107a may request a payment for the license from the requesting user. This step may be performed automatically or manually. For example, initial user registration with the proxy digital video recorder 101 may include registration of payment options for the purpose of obtaining licenses for downloading requested video programs. Server 107a and proxy digital video recorder 101 may therefore conduct the transaction automatically to obtain a license from the user for the requested program. Alternatively, a prompt may be generated and displayed on user computer 108 asking a requesting user for payment for the license. The user may then select a pre-registered payment option or input a new one using user computer 108 to complete the transaction and obtain and license. Any payment method may be implemented as desired.

In step 404, the user is preferably granted a license once the payment transaction is completed. Additional services may also be offered. Instead of a license for the single video program, the program provider may have optional packages available for purchase. For example, a license may be granted by the program provider for an entire series, instead of a single episode of the series. Alternatively, a subscription to the program provider network may be offered.

FIG. 5 is flow chart representing a continuing sequence of steps from FIG. 4, describing the process by which the proxy digital video recorder 101 may monitor and commence recording of broadcast digital programming, and send the recorded program to the digital video recorder unit 102 for playback. In step 501, the proxy digital video recorder unit 101 may monitor whether the current time is concurrent with a time for a scheduled broadcast. If it is not, then in step 502, the proxy digital video recorder 101 preferably waits for a polling period before repeating the query of step 501. If it is determined that the current time is concurrent with a time for a scheduled broadcast, then, in step 503, the proxy digital video recorder 101 preferably commences recording of the scheduled broadcast program, which may be stored in cloud storage resources, making it directly accessible to subsequent users without necessitating another broadcast recording or download.

Once recording is complete in step 503, the proxy digital video recorder 101 preferably determines in step 504 the format of the target proxy digital video recorder unit 102 using cloud-based resources. This information may be retrieved from identification information supplied by or obtained from the requesting user (for example, via the identification component 105 described above). The format of the downloaded video program is preferably known based on the program provider network it was downloaded from. If the program provider network format does not match a playable digital video recorder unit 102 format, then, in step 505, using cloud-based resources, the stored recorded video program is preferably converted from the program provider network format to a format compatible with digital video recorder unit 102. Finally, in step 506, the converted recorded video program is transmitted from the cloud-based proxy digital video recorder 101 over network 110 to the digital video recorder unit 102. In step 507, the recorded video program may now be ready for playback on media device 109.

Alternatively, if network program providers maintain downloadable copies of programming on (for example) provider servers 107 and 107a, there may be no need to wait for a broadcast of the program. Instead, proxy digital video recorder 101 may automatically initiate download of the requested program once the appropriate license has been obtained (if necessary).

Proxy digital video recorder 101 preferably allows users to set up customizable download schedules. For example, a user may desire that a scheduled program be downloaded while the user is sleeping, so that normal Internet access is not hindered by bandwidth intensive high-speed download from provider server 107, 107a. Proxy digital video recorder 101 may, therefore, be accessed (remotely or locally, depending on the implementation) and instructed to initiate download of the requested program in the early morning hours when the user is asleep.

Similarly, proxy digital video recorder 101 preferably allows users having more than one digital video recorder 102, 102a to specify which of the user's digital video recorders (the target digital video recorder) should receive the converted recorded video program transmitted from proxy digital video recorder 101 over network 110. For example, the user may have a digital video recorder 102 (e.g., Windows® Media Center DVR) and another digital video recorder 102a (e.g., Dish Network® DVR). The proxy digital video recorder 101 may allow for the user to specify the target digital video recorder 102 and/or 102a for a requested program or specify preferences where a subset of requested programs may be transmitted to one digital video recorder 102, while other requested programs may be transmitted to other digital video recorders 102a. The preferences relating to this type of target digital video recorder routing may include (but are not limited to) which program is being recorded or the content of programs to be recorded. For instance, a user may specify that all requested sports programs be transmitted to a digital video recorder 102 (e.g., Windows® Media Center) that may be operatively connected to media device 109 (e.g., a large screen television in the user's home) and program requests for news may be transmitted to another digital video recorder 102a (e.g., Dish® Network) operatively connected to media device 109a (e.g., a television in the user's office).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of this disclosure may be embodied as a system, method or computer program product. Accordingly, aspects of this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A proxy digital video recording system, comprising:
a processor; and
memory comprising program instructions, wherein the program instructions are executable by the processor to:
receive a request to record a video program from a requesting user;
request the video program from a server associated with a first provider;
receive and store the requested video program according to a first provider format;
determine a digital video format of a digital video recorder associated with the requesting user;
convert the stored video program from the first provider format to the digital video format; and
transmit the converted video program to the digital video recorder.

2. The proxy digital video recording system of claim 1, further comprising a cloud-based system for storing the requested video program so that only a single instance of the requested video program is stored for multiple requesting users.

3. The proxy digital video recording system of claim 1, wherein the program instructions are executable by the processor to:
identify one of a plurality of digital video recorders associated with the requesting user to which the requested video program is to be transmitted; and
transmit the converted video program to the identified one of a plurality of digital video recorders associated with the requesting user.

4. The proxy digital video recording system of claim 3, wherein the program instructions are executable by the processor to identify one of a plurality of digital video recorders associated with the requesting user to which the requested video program is to be transmitted based on a preference set by the requesting user.

5. The proxy digital video recording system of claim 1, wherein the preference set by the requesting user is based on content of the requested video program.

6. The proxy digital video recording system of claim 1, wherein the program instructions are executable by the processor to:
determine a second digital video format of a second digital video recorder associated with the requesting user;
convert the stored video program from the first provider format to the second digital video format; and
transmit the converted video program stored in the second digital video format to the second digital video recorder.

7. The proxy digital video recording system of claim 1, wherein the request to record a video program is generated when the requesting user selects a link on a web page.

8. The proxy digital video recording system of claim 7, wherein the link is an HTML link embedded in the web page and includes instructions for scheduling the requested video program.

9. The proxy digital video recording system of claim 8, further comprising a scheduling component for receiving the selected link, the scheduling component including:
an identification component for determining the identity of the requesting user; and
a link analysis component for parsing the instructions included within the link.

10. The proxy digital video recording system of claim 9, wherein the identification component determines the digital video format of a digital video recorder associated with the requesting user.

11. The proxy digital video recording system of claim 7, wherein the program instructions are further executable by the processor to determine whether the requesting user subscribes to the first provider.

12. The proxy digital video recording system of claim 11, wherein the program instructions are executable by the processor to obtain a license from the first provider before requesting and storing the video program from the first provider according to the first provider format if the requesting user is not a subscriber to the first provider.

13. A computer-implemented method for proxy-based digital video recording, the method being implemented on a computer system having a processor and memory, the method comprising:
receiving with the processor a request to record a video program from a requesting user;
transmitting with the processor a request for the video program over a network to a first provider server;
receiving with the processor and storing in memory the requested video program according to a first provider format;
determining with the processor a digital video format of a digital video recorder associated with the requesting user;
converting with the processor the stored video program from the first provider format to the digital video format; and
transmitting with processor the converted video program to the digital video recorder.

14. The method of claim 13, further comprising storing the requested video program in a cloud-based system so that only a single instance of the requested video program is stored for multiple requesting users.

15. The method of claim 13, further comprising:
identifying with the processor one of a plurality of digital video recorders associated with the requesting user to which the requested video program is to be transmitted; and
transmitting the converted video program to the identified one of a plurality of digital video recorders associated with the requesting user.

16. The method of claim 15, wherein the processor identifies one of a plurality of digital video recorders associated with the requesting user to which the requested video program is to be transmitted based on a preference set by the requesting user.

17. The method of claim 16, wherein the preference set by the requesting user is based on content of the requested video program.

18. The method of claim 13, further comprising:
determining with the processor a second digital video format of a second digital video recorder associated with the requesting user;
converting with the processor the stored video program from the first provider format to the second digital video format; and
transmitting with the processor the converted video program stored in the second digital video format to the second digital video recorder.

19. The method of claim 13, wherein the request to record a video program is generated when the requesting user selects a link on a web page.

20. The method of claim 19, wherein the link is an HTML link embedded in the web page and includes instructions for scheduling the requested video program.

21. The method of claim 20, further comprising
providing a scheduling component for receiving the requested link, the scheduling component including an identification component and a link analysis component;
determining the identity of the requesting user with the identification component; and
parsing the instructions included within the link with the link analysis component.

22. The method of claim 21, wherein the identification component determines the digital video format of a digital video recorder associated with the requesting user.

23. The method of claim 19, further comprising determining with the processor whether the requesting user subscribes to the first provider.

24. The method of claim 23, further comprising obtaining with the processor a license from the first provider before requesting and storing the video program from the first provider server according to the first provider format if the requesting user is not a subscriber to the first provider.
